(19) United States
(12) Patent Application Publication
(10) Pub. No.: US 2011/0147997 A1
(43) Pub. Date: Jun. 23, 2011

(54) INJECTION MOLDING DEVICE

(75) Inventor: Elias Mora, Chula Vista, CA (US)

(73) Assignee: Formula Plastics, Inc., Tecate, CA (US)

(21) Appl. No.: 12/968,673

(22) Filed: Dec. 15, 2010

Related U.S. Application Data
(60) Provisional application No. 61/287,667, filed on Dec. 17, 2009.

(51) Int. Cl. B29C 45/40

(52) U.S. Cl. 264/328.1; 425/556

(57) ABSTRACT

Methods and devices for forming plastic molded products are provided herein. In one embodiment, a mold for forming plastic molded products includes a stripper plate, the stripper plate including an opening and a countersunk sleeve around the opening. The mold also includes a cavity plate positioned on the side of the stripper plate comprising the countersunk sleeve, and a back plate positioned on the side of the stripper plate opposite the countersunk sleeve.

### RELATED APPLICATIONS

This application claims the benefit of U.S. Provisional Application No. 61/287,667, filed Dec. 17, 2009, which is hereby incorporated by reference in its entirety.

### BACKGROUND

1. Field of the Invention

The field of the invention relates to injection molding processes for soft vinyl and other flexible, soft materials, and more particularly to methods and devices for removing a runner from a mold.

2. Description of the Related Art

Many plastic materials are manufactured using injection molding processes. In a typical injection molding process, plastic granules are heated and forced into one or more mold cavities formed between plates, where the material cools and hardens into the shape or contour of the mold cavity. The injection-molded product is then removed from the mold cavity. Injection molding offers many advantages, including reduced production time, high production rates, repeatable high tolerances, and minimal material waste.

Injection molding processes can use two or more molds, or dies, to produce plastic products. In a two-mold process, for example, an injection mold (A plate) and an ejector mold (B plate) are provided. One or more mold cavities are formed between the assembled injection mold and ejector mold. Molten plastic enters the mold cavity through a sprue in the injection mold. In many cases, the plastic is directed into the mold cavity through channels, or runners, formed between and/or machined into the faces of the injection mold and the ejector mold. The plastic fills the cavity to form the desired part. The amount of plastic material needed to fill the sprue, the runner(s), and the cavity or cavities is a shot.

To remove the molded product, the injection mold and the ejector mold are separated to open the mold. In many designs, the molded part remains on the ejector (B) side of the mold when the mold is opened, drawing the runner, the sprue, and the molded part out of the injection (A) side. The molded part is ejected from the ejector (B) side, and cut away from the runner system. More complex systems, including three-plate mold designs, are also commonly used.

In some cases, the molded product remains on the injection (A) side when the mold is opened. Thus, the development of methods and devices to efficiently and reliably remove molded products from one or more dies remains a significant challenge in the design of injection molding systems.

### SUMMARY OF THE CERTAIN EMBODIMENTS

Methods and devices for maintaining a runner in place over a stripper plate in a mold are provided. In one embodiment, a mold for forming plastic molded products includes a stripper plate, the stripper plate including an opening and a countersunk sleeve around the opening. The mold also includes a cavity plate positioned on the side of the stripper plate comprising the countersunk sleeve, and a back plate positioned on the side of the stripper plate opposite the countersunk sleeve.

In another embodiment, a device for maintaining a runner in place when a mold is opened is provided. The device includes a stripper plate that includes a countersunk sleeve around an opening for a backplate pin.

Yet another embodiment provides a method of maintaining a runner in place over a stripper plate in a mold when the mold is opened. The method includes forming a countersunk sleeve around a backplate pin opening in the stripper plate.

### BRIEF DESCRIPTION OF THE DRAWINGS

FIG. 1 is a partial cross-sectional view of an embodiment of a prior art three-plate injection molding device.

FIG. 2 is a partial cross-sectional view of the prior art device of FIG. 1 after plastic has been injected into the device.

FIG. 3 is a partial cross-sectional view of the prior art device of FIG. 1 illustrating the removal of a runner from the device.

FIG. 4 is a partial cross-sectional view of an embodiment of an injection molding device after plastic has been injected into the device.

FIG. 5 is a partial cross-sectional view of the device of FIG. 4 illustrating the removal of a runner from the device.

FIG. 6 is a perspective view of an embodiment of a runner formed in the device of FIG. 4.

### DETAILED DESCRIPTION

Any feature or combination of features described herein are included within the scope of the present invention provided that the features included in any such combination are not mutually inconsistent as will be apparent from the context, this description, and the knowledge of one skilled in the art. In addition, any feature or combination of features may be specifically excluded from any embodiment of the present invention. For purposes of summarizing the present invention, certain aspects, advantages, and novel features of the present invention are described herein. Of course, it is to be understood that not necessarily all such aspects, advantages, or features will be embodied in any particular embodiment of the present invention.

In reference to the disclosure herein, for purposes of convenience and clarity only, directional terms, such as, top, bottom, left, right, up, down, upper, lower, over, above, below, beneath, rear, and front, may be used. Such directional terms should not be construed to limit the scope of the invention in any manner. It is to be understood that embodiments presented herein are by way of example and not by way of limitation. The intent of the following detailed description, although discussing exemplary embodiments, is to be construed to cover all modifications, alternatives, and equivalents of the embodiments as may fall within the spirit and scope of the invention.

### A Prior Art Injection Molding Device

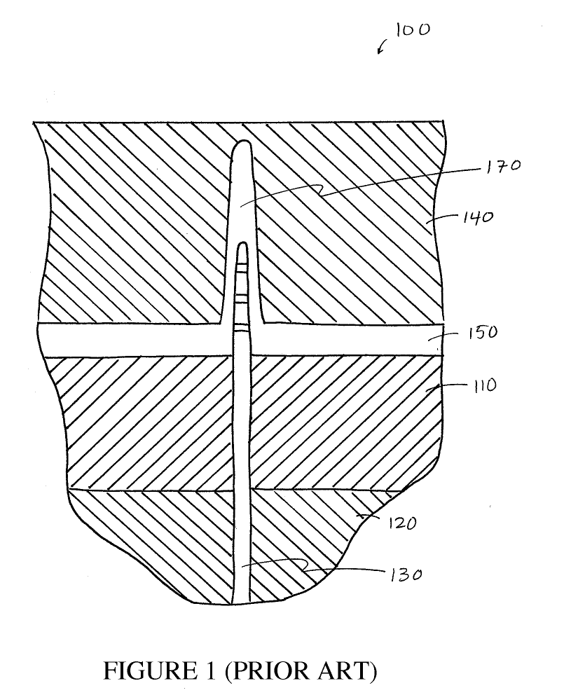

FIG. 1 is a partial cross-sectional view of an embodiment of a prior art three-plate injection molding device 100. The device 100 includes a stripper plate 110, a back plate 120, and a back plate pin 130 that passes through the stripper plate 110. The device 100 also includes a cavity plate or runner plate 140, positioned opposite the stripper plate 110. When the mold is assembled for injection molding, a runner space 150 is formed between the cavity plate 140 and the stripper plate 110. A molded product is formed by injecting molten plastic into a product mold cavity (not shown) also formed between the stripper plate 110 and the cavity plate 140. The final molded product is not shown in FIG. 1. Molten plastic is directed into the mold cavity through the runner space 150 formed between the stripper plate 110 and the cavity plate 140.

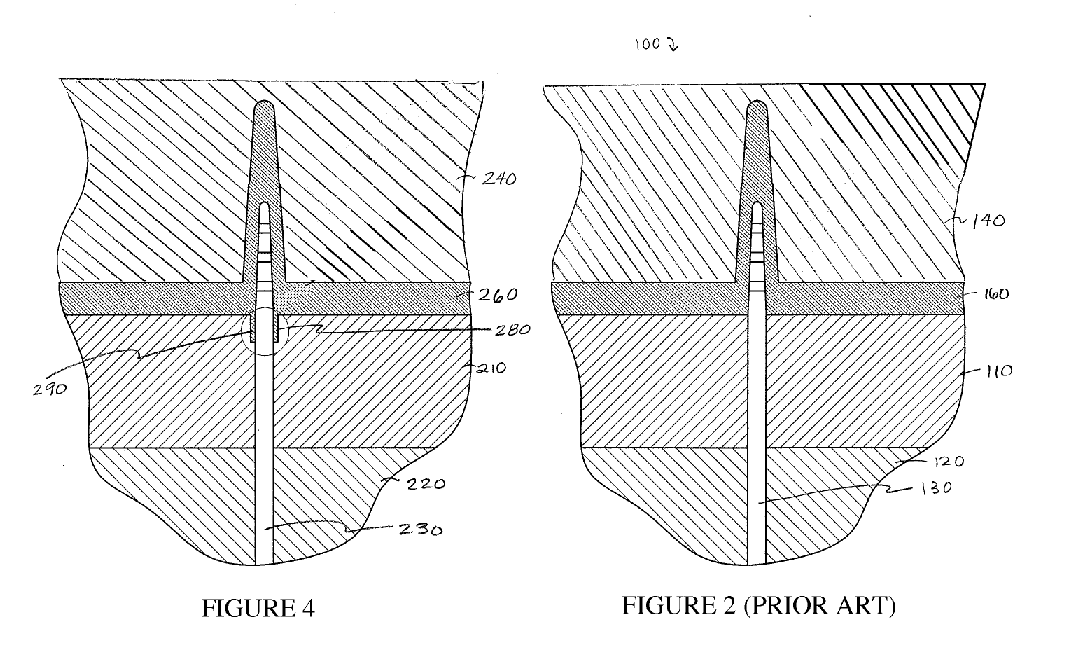

FIG. 2 is a partial cross-sectional view of the injection molding device 100 after plastic has been injected into the product mold cavity to form the molded product. The molten plastic hardens in the product mold cavity as well as in the runner space 150 of FIG. 1. The hardened plastic that has formed in the runner space 150 of FIG. 1 is illustrated in FIG. 2 as a runner 160. Thus, the runner 160 is formed in the runner space 150 between the stripper plate 110 and the cavity plate 160 as a byproduct of forming the molded product. As will be described in greater detail below, there may be multiple runner spaces 150, and multiple corresponding runners 160, formed in the device 100 in order to form one or more molded products.

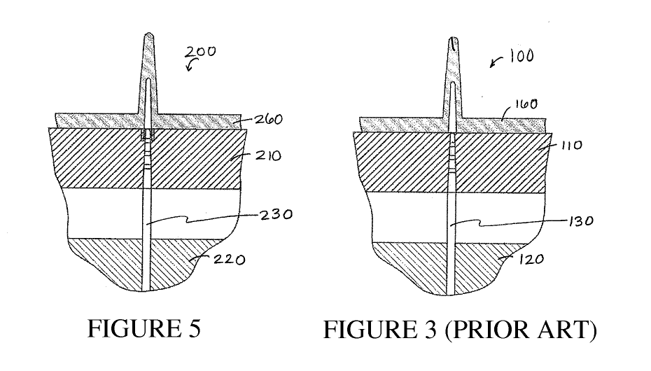

FIG. 3 is a partial cross-sectional view of the injection molding device 100 illustrating the removal of the runner 160 from the device 100. In a typical prior art three-plate injection molding device such as the device 100, the final molded product (not shown) is removed from the mold by moving or pulling the cavity plate 140 (not shown) up, or away from the molded product and the runner 160. As shown in FIG. 3, this leaves the runner 160 formed on the stripper plate 110. The back plate 120 and the back plate pin 130 are then moved or pulled down, or away from the runner 160, as shown in FIG. 3. The runner or runners 160 are then removed.

In some cases, one or more of the runners 160 stick to the cavity plate 140 when the mold is opened and the cavity plate 140 is pulled away from the stripper plate 110. For example, referring again to FIG. 1, the runner 160 can remain stuck inside a space 170 formed inside the cavity plate 140, instead of remaining disposed on the stripper plate 110 as desired. Soft materials in particular can have a tendency to remain stuck to or inside of the cavity plate 140.

### An Improved Device for Maintaining a Runner in Place Over a Stripper Plate

FIG. 4 is a partial cross-sectional view of an embodiment of a three-plate injection molding device 200 according to the present invention. The device 200 includes a stripper plate 210, a back plate 220, and a back plate pin 230 that passes through the stripper plate 210. The device 200 also includes a cavity plate 240, positioned opposite the stripper plate 210. A runner 260 formed between the stripper plate 210 and cavity plate 240 is illustrated in FIG. 4. Embodiments of the present invention include a countersunk sleeve 280 formed in the stripper plate 210 at the opening for the back plate pin 230. The countersunk sleeve 280 may be formed in the stripper plate 210 by machining the sleeve into, for example, the stripper plate 110 illustrated in FIG. 1. When plastic is injected into the space 250 (not shown) between the stripper plate 210 and cavity plate 240, plastic flows into and hardens in the sleeve 280, forming a flange 290 on the runner 260.

Embodiments having the sleeve 280 in the stripper plate 210, and the corresponding formation of the flange 290 on the runner 260, can improve the process of removing the runner 260 from the device 200. When the mold is opened and the cavity plate 240 is pulled away from the stripper plate 210, the runner 260 remains positioned on the stripper plate 210 and does not stick to or remain stuck in the cavity plate 240 as it is pulled away and/or removed. Embodiments of the sleeve 280 are also advantageous because the flange 290 can be formed with a relatively small amount of additional plastic material.

FIG. 5 is a partial cross-sectional view of the injection molding device 200 illustrating the removal of the runner 260 from the device 200. As described above with reference to FIG. 3, the final molded product (not shown) is removed from the mold by moving or pulling the cavity plate 240 up, away from the molded product and the runner 260. In embodiments of the device 200 described herein, the one or more runners 260 do not stick to the cavity plate 240 when the mold is opened and the cavity plate 240 is moved away from the runner 260 and the stripper plate 210. Thus, the molded product and the runner(s) 260 remain positioned on the stripper plate 210.

The back plate 220 and the back plate pin 230 are then moved or pulled down, or away from the runner 260, as shown in FIG. 5. The molded product and the runner 260, including the flange 290, are ejected from the stripper plate 210. The runner(s) 260 are then removed, such as by cutting the runners off of the molded product to form a finished product.

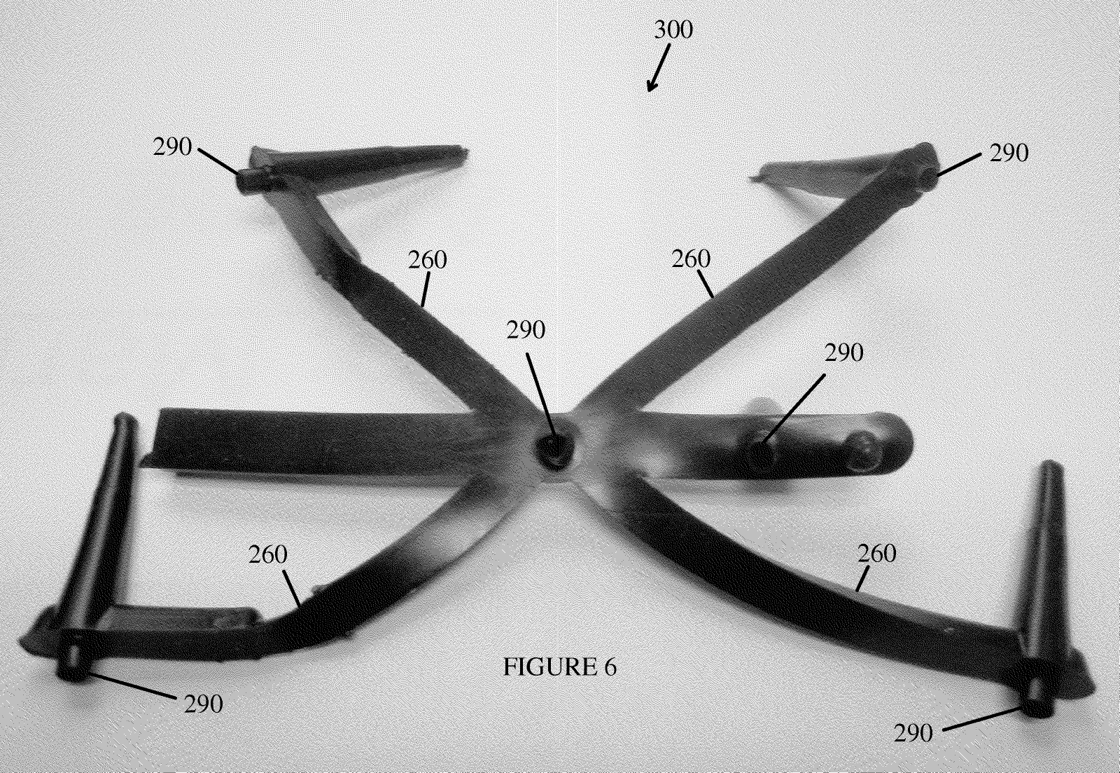

FIG. 6 shows a runner 300 formed in the device 200. The runner 300 includes four runners 260, corresponding to four runner spaces 250 provided to form one or more molded products. Flanges 290 formed by sleeves 280 are illustrated on two of the runners 260.

Persons of skill in the art will understand that while embodiments of a countersunk sleeve 280 are described herein with reference to a three-plate injection mold, two-mold injection molding devices can also include one or more sleeves 280 to improve removal of runners from the mold.

The above-described embodiments have been provided by way of example, and the present invention is not limited to these examples. Multiple variations and modifications to the disclosed embodiments will occur, to the extent not mutually exclusive, to those skilled in the art upon consideration of the foregoing description. Additionally, other combinations, omissions, substitutions and modifications will be apparent to the skilled artisan in view of the disclosure herein. Accordingly, the present invention is not intended to be limited by the disclosed embodiments.

What is claimed is:

1. A mold for forming plastic molded products, the mold comprising:
a stripper plate, the stripper plate comprising an opening and a countersunk sleeve around the opening;
a cavity plate positioned on the side of the stripper plate comprising the countersunk sleeve; and
a back plate positioned on the side of the stripper plate opposite the countersunk sleeve.

2. The mold of claim 1, wherein the cavity plate is positioned to form a cavity between the stripper plate and the cavity plate.

3. The mold of claim 2, wherein a runner is formed when molten plastic is injected into the cavity.

4. The mold of claim 3, wherein the runner is maintained in position over the stripper plate when the back plate and the cavity plate are moved away from the stripper plate.

5. A device for maintaining a runner in place when a mold is opened, the device comprising a stripper plate comprising a countersunk sleeve around an opening for a backplate pin.

6. The device of claim 5, wherein the device further comprises a backplate pin.

7. The device of claim 6, wherein the countersunk sleeve is disposed around the backplate pin.

8. The device of claim 6, further comprising a back plate coupled to the back plate pin and configured to move the back plate pin through the opening in the stripper plate.

9. The device of claim 5, further comprising a cavity plate positioned to form a cavity between the cavity plate and the stripper plate.

10. The device of claim 9, wherein injecting plastic into the cavity forms a runner between the cavity plate and the stripper plate.

11. The device of claim 10, wherein plastic injected into the cavity flows into and hardens in the countersunk sleeve.

12. The device of claim 11, wherein plastic that hardens in the countersunk sleeve forms a flange on the runner.

13. A method of maintaining a runner in place over a stripper plate in a mold when the mold is opened, the method comprising forming a countersunk sleeve around a backplate pin opening in the stripper plate.
